(19) United States
(12) Patent Application Publication
(10) Pub. No.: US 2010/0143750 A1
(43) Pub. Date: Jun. 10, 2010

(54) PERPENDICULAR MAGNETIC RECORDING MEDIUM

(75) Inventors: Toshio Sugimoto, Kawasaki-shi (JP); Ryo Kurita, Kawasaki-shi (JP); Ajan Antony, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/532,122

(22) PCT Filed: May 22, 2007
(86) PCT No.: PCT/JP2007/000260

§ 371 Date: Jan. 26, 2010

(51) Int. Cl. G11B 5/667

(52) U.S. Cl. 428/828.1

(57) ABSTRACT

A perpendicular magnetic recording medium includes: a nonmagnetic substrate; a soft magnetic backing layer formed above the nonmagnetic substrate; a nonmagnetic intermediate layer formed on the soft magnetic backing layer; and a magnetic recording layer formed on the nonmagnetic intermediate layer, the magnetic recording layer including a first ferromagnetic recording layer having perpendicular magnetic anisotropy, a coupling layer formed on the first ferromagnetic recording layer and made of Pd, Pt or alloy of Pd and Pt, and a second ferromagnetic recording layer formed on the coupling layer and having perpendicular magnetic anisotropy.

### FIELD OF THE INVENTION

The present invention relates to a perpendicular magnetic recording medium, and more particularly to a perpendicular magnetic recording medium having a plurality of recording layers stacked via a coupling layer or layers.

### DESCRIPTION OF THE RELATED ART

An in-plane magnetic recording method has been used for a magnetic recording apparatus in which a magnetization direction of a magnetic recording layer is aligned in an in-plane direction. The in-plane magnetic recording method is associated with the problem that as a magnetic domain is made small in order to realize high density recording, recorded information is erased because of thermal fluctuation.

It is recognized that high density recording is realized by a magnetic recording method which applies a magnetic field along a direction perpendicular to the surface of a magnetic recording layer disposed on a soft magnetic backing layer.

However, even with a perpendicular magnetic recording medium, it is not easy to maintain the good conditions on both the thermal fluctuation resistance characteristics and a signal to noise (SN) ratio.

Japanese Patent Laid-open Publication No. 2003-157516 proposes the structure that an intermediate layer is formed on a first magnetic layer, and a second magnetic layer is formed on the intermediate layer. The first and second magnetic layers are made of, e.g., Co (66 at %) Pt (18 at %) Cr (16 at %), and the intermediate layer is made of Ru—Ti alloy or Hf. It is described that noises generated in the first and second magnetic layers are independent so that an SN ratio can be improved, and that the first and second magnetic layers are not separated magnetically so that it is possible to obtain good thermal fluctuation resistance characteristics.

Japanese Patent Laid-open Publication No. 2006-48900 teaches that comparison between ferrimagnetic coupling and ferromagnetic coupling of first and second magnetic layers coupled by a coupling layer indicates that the higher an exchange coupling energy becomes, the ferromagnetic coupling increases thermal stability the more similar to the ferrimagnetic coupling, and improves the recording feasibility the more as different from the ferrimagnetic coupling. A magnetically coupled recording medium of this type is called an exchange coupled composite (ECC) medium.

It also teaches that when magnetizations of the first and second magnetic layers are inverted, an inverting magnetic field necessary for inverting magnetization becomes weaker when magnetization of one layer is inverted after inverting magnetization of the other layer, and hence the product of a uniaxial anisotropy constant and a thickness of one magnetic layer having a weaker anisotropic magnetic field is smaller than the product of a uniaxial anisotropy constant and a thickness of the other magnetic layer. It teaches that this configuration improves thermal stability and provides the effect of the weakened inverting magnetic field.

It is described that the material of the first and second magnetic layers is preferably ferromagnetic material containing at least Co and Pt, that the first magnetic layer is more preferably a granular magnetic layer having magnetic crystalline particles dispersed in nonmagnetic substance, that the coupling layer is made of at least one element selected from a group consisting of V, Cr, Fe, Co, Ni, Cu, Nb, Mo, Ru, Rh, Ta, W, Re and Ir or alloy whose main composition is at least one element in the group, and that the coupling layer has a thickness of 2 nm or thinner, or more preferably 0.3 nm or thinner, 0.3 nm or thinner for the material other than Fe, Co and Ni, or preferably in a range of 1.2 nm to 2 nm. It is also described that Pd and Pt are not suitable because using Pd and Pt results in a stronger inversion magnetic field.

### Patent Document 1: Japanese Patent Laid-open Publication No. 2003-157516

### Patent Document 2: Japanese Patent Laid-open Publication No. 2006-48900

### DISCLOSURE OF THE INVENTION

The present inventors have confirmed experimentally that if Ru or Cu is used for the coupling layer, a thickness of the coupling layer is required to be set to 0.3 nm or thinner. Forming a layer having a thickness of 0.3 nm or thinner requires too narrow a manufacture process margin.

An object of the present invention is to provide a perpendicular magnetic recording medium having a wide margin of a coupling layer forming process, easy to write and hard to be rewritten by adjacent bit writing.

According to one aspect of the present invention, there is provided a perpendicular magnetic recording medium including: a nonmagnetic substrate; a soft magnetic backing layer formed above the nonmagnetic substrate; a nonmagnetic intermediate layer formed on the soft magnetic backing layer; and a magnetic recording layer formed on the intermediate layer, the magnetic recording layer including a first ferromagnetic recording layer having perpendicular magnetic anisotropy, a coupling layer formed on the first ferromagnetic recording layer and made of Pd, Pt or alloy of Pd and Pt, and a second ferromagnetic layer formed on the coupling layer and having perpendicular magnetic anisotropy

It has been found that if the coupling layer is made of Pd or Pt, improved characteristics are obtained in a broadened thickness range. Since the thickness range is broadened, a margin of a coupling layer manufacture process is expanded. By forming samples and measuring characteristics, it has been found that it is possible to manufacture a perpendicular magnetic recording medium which is easy to write, hard to be rewritten by adjacent bit writing. Since similar characteristics are obtained by a Pd coupling layer and a Pt coupling layer, similar effects are expected by alloy of Pd and Pt.

### BRIEF DESCRIPTION OF THE DRAWINGS

FIG. 1A is a schematic cross sectional view illustrating a fundamental structure of a perpendicular magnetic recording medium having an ECC structure, FIG. 1B is a schematic cross sectional view illustrating the structure of a perpendicular magnetic recording medium having the ECC structure according to a first embodiment, and FIGS. 1C and 1D are schematic cross sectional views illustrating the structures of perpendicular magnetic recording media according to first to third comparative examples.

FIGS. 2A and 2B are a graph illustrating a coercive force Hc and a saturated magnetic filed Hs relative to a coupling layer thickness, obtained through measurements of formed samples, and a table of a coercive force Hc/Hc(0) and a saturated magnetic field Hs/Hs(0) normalized by values at a coupling layer thickness of 0 and listed for representative coupling layer thicknesses.

FIGS. 3A and 3B are a graph illustrating a recording magnetic field and an adjacent track allowable magnetic field relative to a coupling layer thickness, obtained through measurements of formed samples of the first embodiment, and a table of Hc, a recording magnetic field, an adjacent track allowable magnetic field, and a ratio of an adjacent track allowable magnetic field to a recording magnetic field listed for representative coupling layer thicknesses.

FIGS. 4A, 4B and 4C are schematic cross sectional views illustrating a perpendicular magnetic recording medium having the ECC structure according to a second embodiment, a perpendicular magnetic recording medium according to a fourth comparative example, and a perpendicular magnetic recording medium according to a fifth comparative example.

FIGS. 5A, 5B and 5C are graphs and a table illustrating recording characteristics obtained through measurements of samples.

FIG. 6A is a schematic cross sectional view illustrating a perpendicular magnetic recording medium having the ECC structure according to a third embodiment, and FIG. 6B is a graph illustrating a change in Hc and Hs relative to a Pd layer thickness, obtained through measurements of samples of the third embodiment.

### DESCRIPTION OF REFERENCE NUMERALS

1 . . . nonmagnetic substrate, 10 . . . soft magnetic backing layer, 11 . . . FeCoB layer, 12 . . . Ru layer, 13 . . . FeCoB layer, 14 . . . FeCoZrTa layer, 15 . . . Ru layer, 16 . . . FeCoZrTa layer, 20 . . . nonmagnetic intermediate layer, 21 . . . Ta layer, 22 . . . NiFeCr layer, 23 . . . Ru layer, 25 . . . NiFeCr layer, 26 . . . Ru layer, 30 . . . magnetic recording layer, 31 . . . granular CoCrPt—SiO₂ first recording layer, 32, 32x . . . coupling layer, 33 . . . CoCrPtB second recording layer, 34, 35 . . . CoCrPt magnetic layer, 37 . . . granular CoCrPt—SiO₂ first recording layer, 38 . . . Pt coupling layer, 39 . . . CoCrPtB second recording layer, 10 . . . protective layer

### BEST MODE FOR CARRYING OUT THE INVENTION

Embodiments of the present invention will now be described with reference to the accompanying drawings.

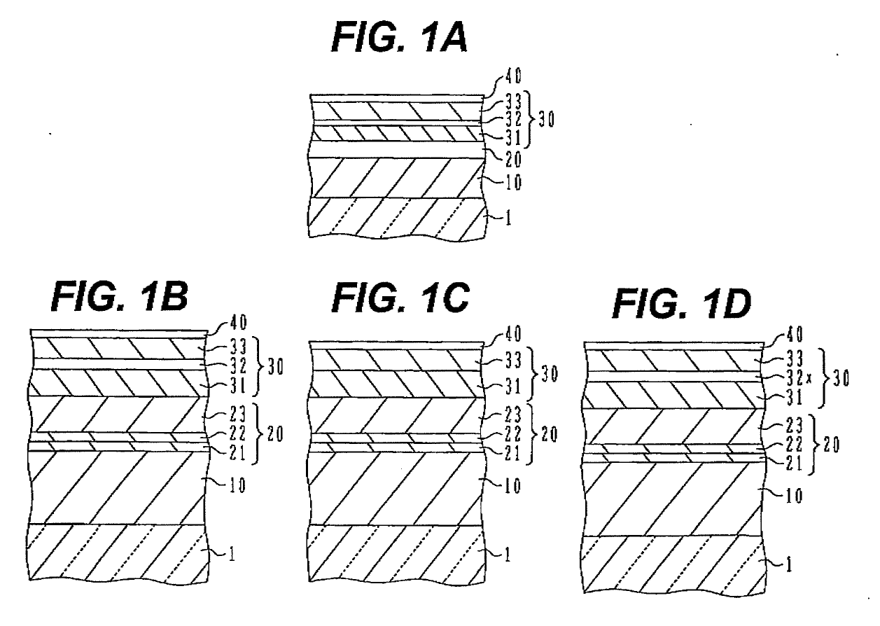

FIG. 1A is a schematic cross sectional view illustrating a fundamental structure of a perpendicular magnetic recording medium having an FCC structure, FIG. 1B is a schematic cross sectional view illustrating the structure of a perpendicular magnetic recording medium having the ECC structure according to a first embodiment, and FIGS. 1C and 1D are schematic cross sectional views illustrating the structures of perpendicular magnetic recording media according to first to third comparative examples.

As illustrated in FIG. 1A, the perpendicular magnetic recording medium having the ECC structure has the structure that a soft magnetic backing layer 10, a nonmagnetic intermediate layer 20, a magnetic recording layer 30 and a protective layer 40 are laminated on a nonmagnetic substrate 1 made of nonmagnetic material such as glass, aluminum and Si. The magnetic recording layer 30 has the structure that ferromagnetic recording layers 31 and 33 are coupled by a coupling layer 32. The soft magnetic backing layer 10 is a magnetic layer for forming a closed magnetic circuit together with a magnetic head, and is made of, e.g., amorphous Co alloy such as CoZrNb and CoZrTa. The soft magnetic backing layer may be made of a lamination of a plurality of layers including a nonmagnetic layer. For example, this layer may be a lamination of an FeCoB layer, an Ru layer and an FeCoB layer. The nonmagnetic intermediate layer 20 is a layer for improving crystallinity of the magnetic recording layer 30, and is made of a single layer or a plurality of layers. The nonmagnetic intermediate layer 20 is made of, e.g., a lamination of an amorphous Ta layer, an NiFeCr layer and an Ru layer, a lamination of an NiFeCr layer and an Ru layer, or the like. The amorphous Ta layer has a function of improving orientation of a crystalline metal layer to be formed on the amorphous Ta layer. The ferromagnetic recording layers 31 and 33 may be made of CoCrPt magnetic alloy such as CoCrPt and CoCrPtB or ferromagnetic material such as CoCrTa and CoPt. The nonmagnetic coupling layer 32 is a layer for realizing a good ECC structure, and is generally made of Ru, Cu or the like. The present inventors have tried Pd and Pt as the material of the nonmagnetic coupling layer 32.

FIG. 1B illustrates a perpendicular magnetic recording medium having the ECC structure according to the first embodiment of the present invention. Description will be made by using the structure of actually manufactured samples by way of example. The crystal structure of material is also indicated by adding fcc for face-centered cubic lattice and hcp for hexagonal close-packed lattice. On a glass substrate 1, a CoZrNb layer 10 having a thickness 50 nm was formed by sputtering at an argon gas pressure of 0.5 Pa and a sputter power of 1 kW. This layer is a single soft magnetic backing layer. An (amorphous) Ta layer 21 having a thickness of 3 nm was formed on the soft magnetic backing layer 10 by sputtering at an argon gas pressure of 0.5 Pa and a sputter power of 0.4 kw, an (fcc) NiFeCr layer 22 having a thickness of 3 nm was formed on the Ta layer by sputtering at an argon gas pressure of 0.5 Pa and a sputter power of 0.1 kW, and an (hcp) Ru layer 23 having a thickness of 20 nm was further formed on the NiFeCr layer 22 by sputtering at an argon gas pressure of 4.0 Pa and a sputter power of 0.4 kW. The Ta layer 21, NiFeCr layer 22 and Ru layer 23 constitute the intermediate layer 20 of a three-layer lamination structure. If the NiFeCr layer is replaced with an NiFe layer, the NiFe layer and the soft magnetic CoZrNb layer via the Ta layer constitute the soft magnetic backing layer of a three-layer structure.

On the intermediate layer 20, a granular (hcp) CoCrPt—SiO₂ first recording layer 31 having a thickness of 13 nm was formed at an argon gas pressure of 4 Pa and a sputter power of 0.4 kW. CoCrPt—SiO₂ has a composition of [Co (66 at %) Cr (13 at %) Pt (21 at %)]₉₁(SiO₂)₉. On the first recording layer 31, an (fcc) Pd layer 32 with a different thickness was formed at an argon gas pressure of 0.5 Pa and a sputter power of 0.1 kW. On the Pd layer 32, an (hcp) CoCrPtB second recording layer 33 having a thickness of 6 nm was formed at an argon gas pressure of 0.5 Pa and a sputter power of 0.4 kw.

The first recording layer 31, coupling layer 32 and second recording layer 33 constitute a recording layer 30 of the ECC structure. In the state that an external magnetic field is not applied, the first and third recording layers 31 and 33 are under a ferromagnetic coupling condition. Perpendicular magnetic anisotropy of the first recording layer of a granular ferromagnetic layer is larger than perpendicular magnetic anisotropy of the second recording layer of a non-granular ferromagnetic layer.

On the recording layer 30, a C layer having a thickness of 3 nm was formed as the protective layer 40. When the perpendicular magnetic recording medium is actually used, a liquid lubricating layer is preferably coated on the protective layer 40. Since the layer above the amorphous Ta layer has an fcc or hcp structure, excellent crystallinity and orientation are obtained and the layer is like an epitaxial layer.

FIG. 1C is a schematic diagram illustrating the structure of a perpendicular magnetic recording medium of the first comparative example. As compared to the structure illustrated in FIG. 1B, the coupling layer 32 is not formed so that this medium does not have the ECC structure. This medium corresponds to a medium whose coupling layer 32 has a thickness of 0. Other structures are the same as those illustrated in FIG. 1B.

FIG. 1D is a schematic diagram illustrating the structure of the perpendicular magnetic recording medium having the ECC structure of the second and third comparative examples. The coupling layer 32x is not made of Pd, but Ru is used for the second comparative example, and Cu is used for the third comparative example. Other structures are the same.

Samples of the first embodiment were formed by changing a thickness of the coupling layer 32 from 0 (first comparative example) to 2.5 nm at a pitch of 0.1 nm. However, at a thickness of 1.9 nm or thicker, the lower layer of the granular magnetic layer and the upper layer are in a decoupling state, and each magnetic layer demonstrates the magnetic characteristics of a single layer. Therefore, description of these magnetic recording media and their drawings are omitted. Samples of the second and third comparative examples were also formed by changing a thickness of the coupling layer 32x at a pitch of 0.1 nm.

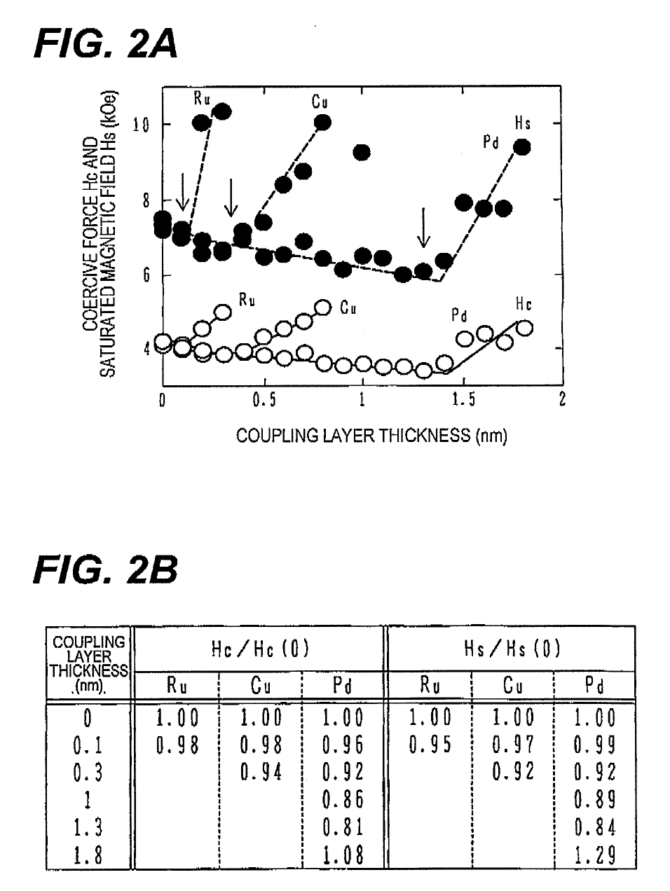

FIGS. 2A and 2B are a graph illustrating a coercive force Hc and a saturated magnetic filed Hs relative to a coupling layer thickness, obtained through measurements of formed samples, and a table of a coercive force Hc/Hc(0) and a saturated magnetic field Hs/Hs(0) normalized by values at a coupling layer thickness of 0 and listed for representative coupling layer thicknesses. In FIG. 2A, the abscissa represents a coupling layer thickness in the unit of nm, and the ordinate represents Hs and Hc in the unit of kOe.

As illustrated in FIG. 2A, in the second comparative example using the coupling layer of Ru, Hc and Hs take minimum values at a coupling layer thickness of 0.1 nm. The Hc value indicates resistance against magnetic recording rewrite to be caused by unknown factors, and represents a barrier height (recording hold force) relative to thermal fluctuation and leak magnetic field to be caused by adjacent area writing. It is preferable that the larger the Hc value is. The Hs value represents a magnetic field necessary for writing, and it is preferable that the smaller the Hs value is. Hc and Hs lower as the coupling layer thickness changes from 0 to 0.1 nm, and at a thickness of 0.2 nm or thicker, Hc ad Hs increase as the coupling layer thickness increases. At a coupling layer thickness of 0.2 nm or thicker, the Hs value becomes larger than that at a coupling layer thickness of 0 (no coupling layer). This suggests that a magnetic field necessary for writing increases and writing becomes difficult. In order not to increase a writing magnetic field, a thickness of the coupling layer is preferably 0.1 nm or thinner.

In the third comparative example having the coupling layer made of Cu, Hc takes a minimum value at a coupling layer thickness of 0.3 nm, starts increasing at a coupling layer thickness of 0.4 nm, and at a coupling layer thickness of 0.5 nm or thicker, becomes larger than that at a coupling layer thickness of 0. Hs takes a minimum value at a coupling layer thickness near at 0.4 nm and 0.5 nm, and increases thereafter as the coupling layer becomes thick. At a coupling layer thickness of 0.4 nm and 0.5 nm, the value increases to the same degree as that at the coupling layer thickness of 0, and at a coupling layer thickness of 0.6 nm, the value increases much more than that at a coupling layer thickness of 0. In order not to increase a magnetic field necessary for writing, a coupling layer thickness is required to be 0.5 nm or thinner, more preferably 0.3 nm or thinner in order to lower a magnetic field necessary for writing.

In the first embodiment sample having the coupling layer made of Pd, Hc lowers as the coupling layer thickness becomes thick, takes a minimum value at a coupling layer thickness of 1.3 nm, starts increasing at a coupling layer thickness of 1.4 nm, and at a coupling layer thickness of 1.5 nm or thicker, becomes larger than that at a coupling layer thickness of 0. Hs takes a minimum value at a coupling layer thickness of about 1.2 nm and 1.3 nm, slightly increases at a thickness of 1.4 nm, and at a thickness of 1.5 nm or thicker, increases greatly and becomes larger than that when the coupling layer is not formed. In order to lower the Hs value and write at a weaker magnetic field more than those of the first comparative example having a coupling layer thickness of 0, it is expected that a coupling layer thickness is preferably set to 1.4 nm or thinner. In order to make it easy to control a manufacture process and increase a margin, it is desired that a coupling layer thickness is set to 0.4 nm or thicker. If a coupling layer thickness is set to 0.4 nm to 1.4 nm, Hs becomes small and the manufacture process margin and controllability are improved considerably.

FIG. 2B is a table illustrating the relation between representative thicknesses of a coupling layer and normalized Hc and Hs. In the second comparative example having the coupling layer of Ru, an Hs lowering range is roughly a coupling layer thickness up to 0.1 nm. In the third comparative example having the coupling layer of Cu, the Hs lowering range is a coupling layer thickness up to 0.3 nm. In contrast, in the first embodiment sample having the coupling layer of Pd, the Hs lowering range is a coupling thickness up to 1.3 nm. As the Pd layer thickness becomes 1.8 nm, Hs and Hc become larger than those without the Pd coupling layer (thickness of 0).

Hs and Hc represent static properties, and dynamic characteristics govern the performance of a magnetic recording apparatus. It is preferable to use a recording magnetic field (represented by Hc_{Write}) instead of Hs, and an adjacent track allowable magnetic field (represented by Hc_{Erase}) instead of Hc. First embodiment samples for dynamic performance measurements were manufactured having Pd coupling layer thicknesses of, 0 nm, 1.0 nm, 1.5 nm, and 1.9 nm.

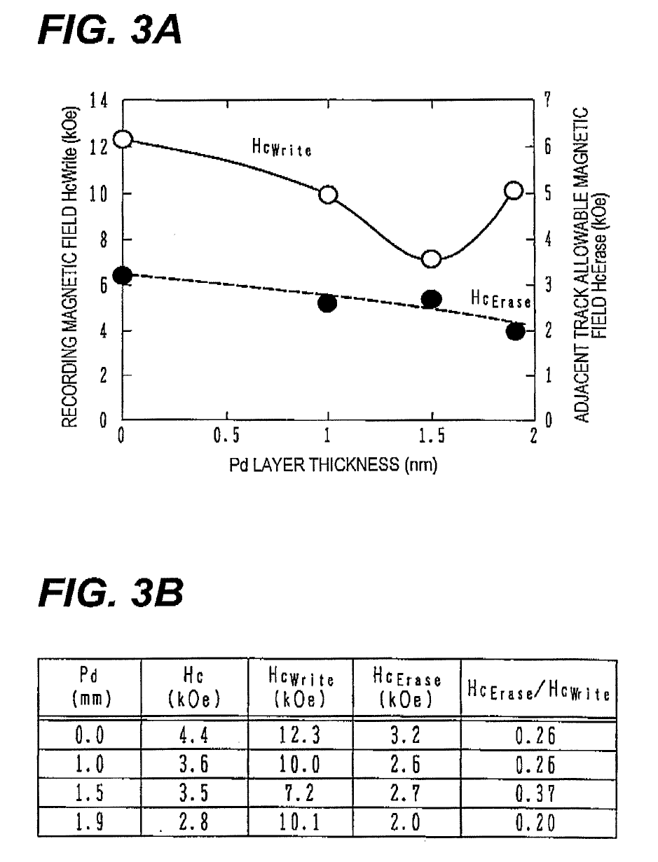

FIGS. 3A and 3B are a graph illustrating a recording magnetic field Hc_{Write} and an adjacent track allowable magnetic field Hc_{Erase} relative to a coupling layer thickness, obtained through measurements of formed samples of the first embodiment, and a table of a coercive force Hc, a recording magnetic field Hc_{Write}, an adjacent track allowable magnetic field Hc_{Erase}, and a ratio Hc_{Erase/}Hc_{Write} of an adjacent track allowable magnetic field to a recording magnetic field Hc_{Write} listed for representative coupling layer thicknesses. In FIG. 3A, the abscissa represents a PD coupling layer thickness in the unit of nm, and the ordinate represents a recording magnetic field Hc_{Write} and adjacent track allowable magnetic field Hc_{Erase} in the unit of kOe.

As illustrated in FIG. 3A, the recording magnetic field Hc_{Write} lowers as the Pd layer becomes thick from 0 nm to about 1.5 nm. The recording magnetic field increases considerably at a Pd layer thickness of 1.9 nm. However, even at a Pd layer thickness of 1.9 nm, the recording magnetic field Hc_{Write} is lower than that without the Pd coupling layer. At the Pd layer thickness of 1.5 nm, the recording magnetic field becomes lower by about 5 kOe than that without the Pd layer (thickness of 0). The adjacent track allowable magnetic field Hc_{Erase} lowers gradually as the Pd layer becomes thick.

The ratio Hc_{Erase/}Hc_{Write} of an adjacent track allowable magnetic field Hc_{Erase} to a recording magnetic field Hc_{Write} illustrated in FIG. 3B is an index representative of that the larger this ratio becomes, it is more easy to write and more difficult to erase. Up to a Pd layer thickness of 1.5 nm, the recording magnetic field Hc_{Write} lowers and the ratio Hc_{Erase/}Hc_{Write} of an adjacent track allowable magnetic field Hc_{Erase} to a recording magnetic field Hc_{Write} increases. At the Pd layer thickness of 1.5 nm, the recording magnetic field becomes lower by about 5 kOe than that without the coupling layer. At a Pd layer thickness of 1.9 nm, the ratio Hc_{Erase/}Hc_{Write} lowers than that without the coupling layer. At a Pd layer thickness of 1.7 nm or thinner, it is expected that the magnetic recording characteristics are improved.

The experiment results illustrated in FIGS. 3A and 3B suggest that a Pd coupling layer thickness is preferably 0.4 nm to 1.7 mm including a manufacture process margin. As compared to the characteristics illustrated in FIG. 2A, there is a difference between preferable Pd layer thickness ranges. This difference may be ascribed to a difference between manufacture lots because of film forming techniques still not established. If the film forming techniques are established, it is expected that an excellent perpendicular magnetic recording medium is manufactured by adopting a Pd coupling layer having a thickness of 0.4 nm to 1.7 nm. At a Pd layer thickness of 0.4 nm to 1.4 nm, it is expected an excellent perpendicular magnetic recording medium is manufactured more reliably.

A magnetic recording apparatus is required to have good read/write characteristics. The write characteristics include overwrite (OW) characteristics of recording data and then recording new data on the recorded data. Overwrite two OW2 (dB) is measured often by performing high density recording for writing short bit length data and thereafter performing low density recording for writing long bit length data on the short bit length data to measure an attenuation of previously written short bit length data. As an attenuation ratio of OW2 becomes high, an effective write core width WCw is likely to become wider. In order to check these characteristics, samples of the second embodiment were formed.

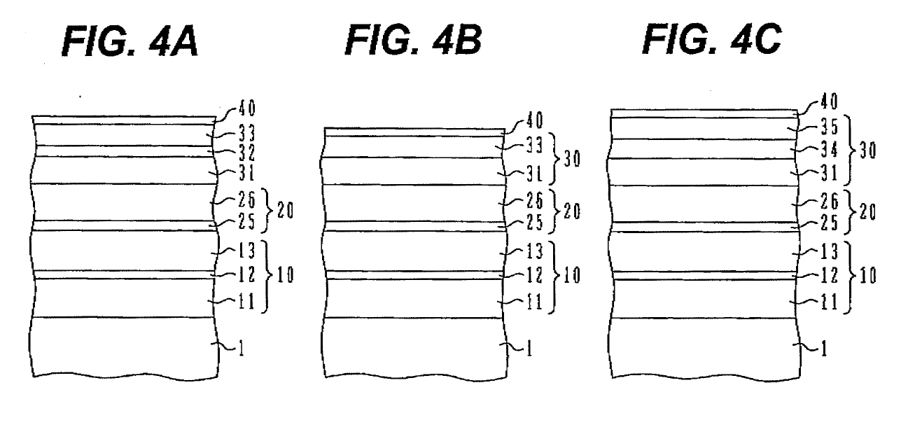

FIGS. 4A, 4B and 4C are schematic cross sectional views illustrating a perpendicular magnetic recording medium having the ECC structure of the second embodiment, a perpendicular magnetic recording medium according to a fourth comparative example, and a perpendicular magnetic recording medium according to a fifth comparative example.

FIG. 4A illustrates the perpendicular magnetic recording medium having the ECC structure of the second embodiment. Description will be made by using the structure of actually formed samples by way of example. On a glass substrate 1, a soft magnetic backing layer 10 was formed by forming an FeCoB layer 11 having a thickness of 25 nm, an Ru layer 12 having a thickness of 0.4 nm and an FeCoB layer 13 having a thickness of 25 nm. On the soft magnetic backing layer 10, an intermediate layer 20 was formed by forming an NiFeCr layer 25 having a thickness of 5 nm and an Ru layer 26 having a thickness of 20 nm. On the intermediate layer 20, a recording layer 30 was formed by forming a granular CoCrPt—SiO₂ first recording layer 31 having a thickness of 11 nm, a Pd coupling layer 32 with a different thickness and a CoCrPtB second recording layer 33 having a thickness of 8 nm. The compositions of the first recording layer 31 and second recording layer 33 are the same as those of the first recording layer 31 and second recording layer 33 of the first embodiment. A C protective layer 30 having a thickness of 3 nm was formed on the recording layer 30.

FIG. 4B illustrates the structure of the fourth comparative example. As compared to the structure illustrated in FIG. 4A, the coupling layer 32 is not formed and therefore the ECC structure does not exist. This structure corresponds to the structure illustrated in FIG. 4A and has a coupling layer 32 thickness of 0. Other structures are the same.

FIG. 4C illustrates the structure of the fifth comparative example. As compared to the second embodiment illustrated in FIG. 4A, a different point resides in that two CoCrPt magnetic layers 34 and 35 are formed on the first recording layer 31 without forming the coupling layer. Other structures are the same as those of the second embodiment.

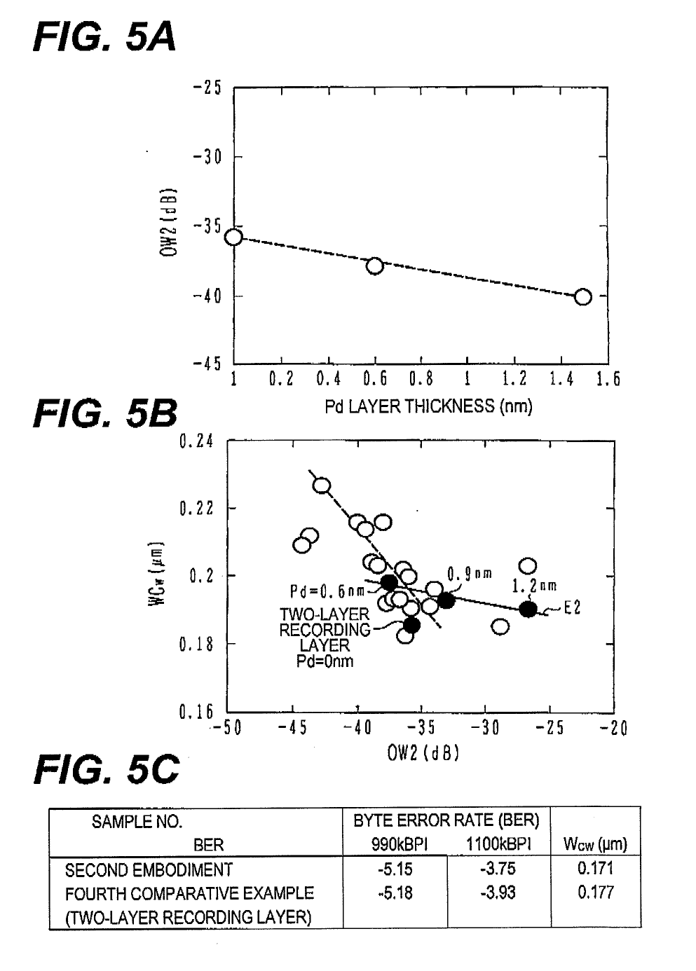

FIGS. 5A, 5B and 5C are graphs and a table illustrating recording characteristics obtained through measurements of samples.

FIG. 5A illustrates a Pd layer thickness dependency of OW2 measured from samples of the second embodiment. The abscissa represent a Pd layer thickness in the unit of nm, and the ordinate represents OW2 in the unit of dB. It indicates that the thicker the PD layer is, the larger the attenuation of OW2 is.

FIG. 5B is a graph illustrating a change in effective write core width WCw with an OW2 attenuation measured from the samples of the second embodiment and the fourth and fifth comparative examples. The abscissa represents OW2 in the unit of dB, and the ordinate represents WCw in the unit of μm. Measured values of the samples of the second embodiment are indicated by interconnecting the values with a solid line E2. A plot affixed with a two-layer recording layer is a plot for the fourth comparative example without the Pd layer (thickness of 0). Other plots are plots for the fifth comparative example illustrated in FIG. 4C. The tendency that as the absolute value of OW2 becomes large, WCw becomes wide, is considerably smaller in the samples of the second embodiment than the fifth comparative example.

FIG. 5C is a table illustrating error rates measured from the samples of the second embodiment having a Pd layer thickness of 1.5 nm and the samples of the fourth comparative example. A byte error rate is improved more than the fourth comparative example. The effective write core width WCw of the fourth comparative example is 0.175 to 0.179 (average 0.177), whereas that of the second embodiment narrows to 0.171 although slightly.

It has been found that more desired characteristics are obtained by using a Pd layer as a coupling layer than by not using a coupling layer or using an Ru layer or a Cu layer as a coupling layer. The characteristics have also been confirmed using a Pt layer as a coupling layer instead of the Pd layer.

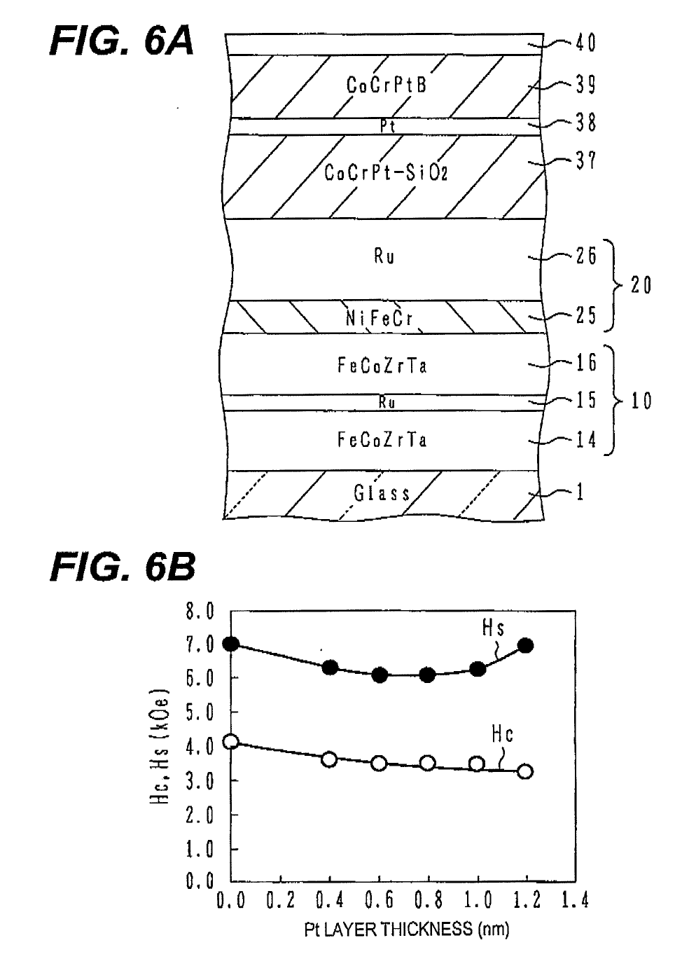

FIG. 6A is a schematic cross sectional view illustrating a perpendicular magnetic recording medium having the ECC structure of the third embodiment, and FIG. 6B is a graph illustrating a change in Hc and Hs relative to a Pd layer thickness, obtained through measurements of samples of the third embodiment.

FIG. 6A illustrates the perpendicular magnetic recording medium having the EC structure of the third embodiment. Description will be made by using the structure of actually formed samples by way of example. On a glass substrate 1, a soft magnetic backing layer 10 was formed by forming an FeCoZrTa layer 14 having a thickness of 25 nm, an Ru layer 15 having a thickness of 0.5 nm and an FeCoZrTa layer 16 having a thickness of 25 nm. On the soft magnetic backing layer 10, an intermediate layer 20 was formed by forming an NiFeCr layer 25 having a thickness of 5 nm and an Ru layer 26 having a thickness of 20 nm. On the intermediate layer 20, a recording layer 30 was formed by forming a granular CoCrPt—SiO₂ first recording layer 37 having a thickness of 11 nm, a Pt coupling layer 38 with a different thickness and a CoCrPtB second recording layer 39 having a thickness of 8 nm. The composition of the first recording layer 37 is [Co (71 at %) Cr (13 at %) Pt (16 at %)]₉₂(SiO₂)₈, and the composition of the second recording layer 39 is Co (61 at %) Cr (20 at %) Pt (15 at %) B (4 at %). A C protective layer 40 having a thickness of 3 nm was formed on the recording layer 30.

FIG. 6B is a graph illustrating a change in Hc and Hs relative to a Pt layer thickness. The abscissa represents a Pt coupling layer thickness in the unit of nm, and the ordinate represents Hs and Hc in the unit of kOe.

As the coupling layer is made of Pt, Hc gradually lowers as a coupling layer becomes thick. Hs lowers first as the coupling layer becomes thick, takes a minimum value near at 0.8 nm, and thereafter increases as the coupling layer becomes thick. Similar to the Pd coupling layer, in the coupling layer thickness range of 0.4 nm to 1.1 nm it is expected that magnetic recording characteristics are obtained being more excellent than those without the Pt coupling layer, when considered synthetically. It is expected that an excellent perpendicular magnetic recording medium is manufactured by adopting a Pt coupling layer having a thickness of 0.4 nm to 1.1 nm.

It is possible to say that an excellent perpendicular magnetic recording medium is manufactured by adopting a Pd or Pt coupling layer if a layer thickness range is 0.4 nm to 1.1 am. Although a coupling layer made of Pd or Pt has been described, similar effects may be expected even if the coupling layer is made of alloy of Pd and Pt. In this case, it is expected that an excellent perpendicular recording medium is manufactured by using a Pd—Pt alloy coupling layer having a thickness of 0.4 nm to 1.1 nm.

The present invention has been described above in connection with the embodiments. The present invention is not limited only to the embodiments.

For example, various modifications and combinations are possible for the structure, material and thickness of the layer other than the coupling layer. It is apparent to those skilled in the art to make various modifications, improvements, combinations and the like.

### INDUSTRIAL APPLICABILITY

A perpendicular magnetic recording medium having an ECC structure.

1. A perpendicular magnetic recording medium comprising:
a nonmagnetic substrate;
a soft magnetic backing layer formed above said nonmagnetic substrate;
a nonmagnetic intermediate layer formed on said soft magnetic backing layer; and
a magnetic recording layer formed on said intermediate layer, said magnetic recording layer including a first ferromagnetic recording layer having perpendicular magnetic anisotropy, a coupling layer formed on said first ferromagnetic recording layer and made of Pd, Pt or alloy of Pd and Pt, and a second ferromagnetic layer formed on said coupling layer and having perpendicular magnetic anisotropy.

2. The perpendicular magnetic recording medium according to claim 1, wherein said first ferromagnetic recording layer and said second ferromagnetic recording layer have a ferromagnetic coupling state under a condition of absence of an applied magnetic field.

3. The perpendicular magnetic recording medium according to claim 1, wherein said first ferromagnetic recording layer has perpendicular magnetic anisotropy larger than perpendicular magnetic anisotropy of said second ferromagnetic recording layer.

4. The perpendicular magnetic recording medium according to claim 3, wherein said first ferromagnetic recording layer is made of a granular magnetic layer containing CoCrPt alloy, and said second ferromagnetic recording layer is made of magnetic alloy of CoCrPt.

5. The perpendicular magnetic recording medium according to claim 1, wherein a thickness of said coupling layer is in a range of 0.4 nm to 1.1 nm.

6. The perpendicular magnetic recording medium according to claim 1, wherein said intermediate layer is made of a plurality of layers, and at least an upper layer of said intermediate layer and said ferromagnetic recording layers have a crystal structure of face-centered cubic lattice or hexagonal close-packed lattice.

7. The perpendicular magnetic recording medium according to claim 1, wherein said intermediate layer includes an NiFeCr layer and an Ru layer formed on said NiFeCr layer, and said first ferromagnetic recording layer is formed on said Ru layer.

8. The perpendicular magnetic recording medium according to claim 1, wherein said soft magnetic backing layer includes a lamination of a FeCoB layer, an Ru layer formed on said FeCoB layer, and an FeCoB layer formed on said Ru layer or a lamination of an FeCoZrTa layer, an Ru layer formed on said FeCoZrTa layer, and an FeCoZrTa layer formed on said Ru layer.

9. The perpendicular magnetic recording medium according to claim 1, wherein said coupling layer is a Pd layer having a thickness of 0.4 nm to 1.7 nm.

10. The perpendicular magnetic recording medium according to claim 9, wherein said coupling layer is a Pd layer having a thickness of 0.4 nm to 1.4 nm.

11. The perpendicular magnetic recording medium according to claim 1, wherein said coupling layer is a Pt layer having a thickness of 0.4 nm to 1.1 nm.
